(19) United States
(12) Patent Application Publication
(10) Pub. No.: US 2024/0346878 A1
(43) Pub. Date: Oct. 17, 2024

(54) OPERATOR ACCESS OF ELECTRONIC GAMING MACHINE

(71) Applicant: IGT, Las Vegas, NV (US)

(72) Inventors: Kevin Higgins, Reno, NV (US); Matthew Levin, Reno, NV (US); Erik B. Petersen, Sparks, NV (US); Jeffery Shepherd, Reno, NV (US)

(21) Appl. No.: 18/756,569

(22) Filed: Jun. 27, 2024

Related U.S. Application Data
(63) Continuation of application No. 17/235,584, filed on Apr. 20, 2021.

(51) Int. Cl. G07F 17/32

(52) U.S. Cl. CPC G07F 17/3234; G07F 17/3227

(57) ABSTRACT

Systems and methods that enable an operator, such as a member of gaming establishment personnel, to access an electronic gaming machine without any physical identifier associated with the operator.

### PRIORITY CLAIM

This application is a continuation of, claims priority to and the benefit of U.S. patent application Ser. No. 17/235,584, filed on Apr. 20, 2021, the entire contents of which is incorporated herein by reference.

### BACKGROUND

In various embodiments, the systems and methods of the present disclosure operate to enable an operator, such as a member of gaming establishment personnel, to access an electronic gaming machine without any physical identifier associated with the operator.

Electronic gaming machines may enable a player to play a game wherein the player may be required to place a wager.

### BRIEF SUMMARY

In certain embodiments, the present disclosure relates to a system including a processor, and a memory device that stores a plurality of instructions. When executed by the processor responsive to receiving data from a first mobile device executing a first mobile device application associated with a player account, the instructions cause the processor to establish a player session in association with the player account. When executed by the processor responsive to receiving, before a termination event occurs in association with the player session and after an occurrence of an intervention event associated with an electronic gaming machine, second data from a second mobile device executing a second mobile device application associated with an operator identifier, the instructions cause the processor to establish an operator session in association with an operator.

In certain embodiments, the present disclosure relates to a system including a processor, and a memory device that stores a plurality of instructions. When executed by the processor following an establishment of a player session without a physical identifier associated with a player and prior to a termination of the player session and responsive to receiving, via a first wireless communication channel, data from a mobile device executing a mobile device application associated with an operator identifier, the instructions cause the processor to establish, at an electronic gaming machine, an operator session associated with the operator identifier. When executed by the processor, the instructions cause the processor to communicate data associated with the electronic gaming machine to the mobile device, wherein data associated with a player is communicated to the mobile device via a second wireless communication channel.

In certain embodiments, the present disclosure relates to a method of operating a system. Responsive to receiving data from a first mobile device executing a first mobile device application associated with a player account, the method includes establishing, by a processor, a player session in association with the player account. Responsive to receiving, before a termination event occurs in association with the player session and after an occurrence of an intervention event associated with an electronic gaming machine, second data from a second mobile device executing a second mobile device application associated with an operator identifier, the method includes establishing, by the processor, an operator session in association with an operator.

Additional features are described, and will be apparent from the following Detailed Description and the figures.

### BRIEF DESCRIPTION OF THE SEVERAL VIEWS OF THE DRAWINGS

FIGS. 1A, 1B, IC, 1D and 1E are flow charts of example processes for operating a system which enables an operator to interface with an electronic gaming machine utilizing an operator mobile device application.

FIGS. 2A and 2B are example graphical user interfaces displayed on an operator mobile device in connection with an operator interfacing with an electronic gaming machine utilizing an operator mobile device application.

FIG. 3 is a schematic block diagram of one embodiment of an electronic configuration of an example electronic gaming machine.

FIGS. 4A and 4B are perspective views of example alternative embodiments of an example electronic gaming machine.

### DETAILED DESCRIPTION

In various embodiments, the systems and methods of the present disclosure operate to enable an operator, such as a member of gaming establishment personnel, to access an electronic gaming machine (“EGM”) without any physical identifier associated with the operator.

In certain embodiments, the system enables a first user, such as a player, to use a first mobile device executing a first mobile device application, to interface with an EGM operating in a first mode of operation, such as a game play mode of operation. In these embodiments, responsive to a second user, such as an operator (e.g., a member of gaming establishment personnel) using a second mobile device executing a second mobile device application to interface with the EGM, the EGM switches to a second mode of operation, such as an operator mode of operation, wherein the operator may resolve any outstanding issues associated with the EGM and/or retrieve information regarding the first user and/or the EGM. For example, the system enables a player to use a mobile device executing a player mobile device application in wireless communication with the EGM to access a player account and establish a game play session at an EGM. In this example, following the EGM locking up due to the player winning a relatively large jackpot award that requires an operator's involvement to pay (i.e., an occurrence of an intervention event), the operator uses an operator mobile device executing an operator mobile device application to wirelessly communicate an operator identifier to the EGM (which causes the EGM to switch to an operator mode of operation associated with the payment of the award). As illustrated by this example, the system of the present disclosure facilitates an EGM to modify how it operates (and specifically what information to display and what functions to enable) based on which of a plurality of different mobile devices executing which of a plurality of different mobile device applications is currently in wireless communication with the EGM.

Such a configuration of multiple mobile devices that are each used to wirelessly exchange data with an EGM (and/or a component of a gaming establishment management system supported by the EGM, such as a slot machine interface board (“SMIB”) associated with the EGM) enables both players and operators to interface with the EGM without the need of any physical instruments (e.g., a physical magnetic striped employee identification card with an employee number encoded on the stripe and/or a physical magnetic striped player tracking card with a player tracking number encoded on the stripe) inserted into a card reader of the EGM. That is, with the advent of enabling players to access player accounts at an EGM using mobile device applications executed by mobile devices (and the corresponding inability of such players to cause any player account termination events by removing any physical instruments inserted into a card reader of the EGM), the system of the present disclosure enables operators to interface with the EGM upon an occurrence of an intervention event that requires operator involvement following the player electronically logging into the EGM and without requiring the player to affirmatively log out from the EGM. Accordingly, to account for different devices being used by different users and specifically, in certain instances, for the need for gaming establishment personnel to interface with an EGM which a player has previously electronically logged into without the use of any physical instruments inserted into the card reader of the EGM, the system determines, based on the device employed by a particular user, the type of user to access an EGM and proceeds with determining which information to display to the user and/or which features and functions to enable on the EGM based on the determined type of user accessing the EGM.

Moreover, such as configuration of employing multiple mobile devices used to wirelessly exchange data with an EGM reduces the amount of physical contact that people have with the EGM which in turn reduces the role of the EGM as a vehicle to potentially transmit diseases between people. For example, by replacing one or more inputs an operator would make at an EGM with inputs the operator instead makes via an operator mobile device (wherein data associated with such inputs are wirelessly communicated to the EGM), the system of the present disclosure fosters a safer environment.

In various embodiments, the system enables a player to attempt to log into a gaming establishment management system using a physical instrument, such as a magnetic striped card, issued to the player and associated with the player account. In these embodiments, the system enables the player to use such a physical instrument associated with a player account to attempt to log into the gaming establishment management system, such as a player loyalty or player tracking system which is configured to track game play and other player activities, and associate player identification information stored in association with the player account with certain activities.

In various embodiments, the system enables a player to attempt to log into a gaming establishment management system using a mobile device executing a player mobile device application. In these embodiments, the system enables the player to use a first mobile device executing a first mobile device application associated with a player account to attempt to log into the gaming establishment management system, such as a player loyalty or player tracking system which is configured to track game play and other player activities, and associate player identification information stored in association with the player account with certain activities. In these embodiments, the system enables such logging into the gaming establishment management system using the first mobile device application of the first mobile device without using a physical instrument, such as a magnetic striped card, issued to the player and associated with the player account.

In certain embodiments wherein the system enables a player to attempt to log into a gaming establishment management system using a mobile device executing a player mobile device application, following the launching of a player mobile device application, such as following the player selecting an image associated with a player tracking account card stored via a digital wallet application or following the player mobile device application retrieving data associated with a player tracking account stored via a digital wallet application, the player mobile device application prompts the player to cause the mobile device to engage the EGM (e.g., the player taps the mobile device to a player tracking card reader or other designated location(s) of the EGM). After such engagement (or after the launching of the player mobile device application if no mobile device engagement is required), the player mobile device application attempts to pair with the EGM by communicating, via one or more wireless communication protocols (including, but not limited to: Bluetooth™, Bluetooth Low Energy (“BLE”), one or more cellular communication standards (e.g., 3G, 4G, 5G, LTE), one or more Wi-Fi compatible standards, and one or more short range communication protocols (e.g., a near field communication (“NFC”) protocol), player tracking account data stored by the mobile device to the EGM and/or a component of a gaming establishment management system located inside the EGM, such as the SMIB. In one such embodiment, the player mobile device application communicates data to an antenna, such as a BLE antenna, which interfaces with a card reader of a player tracking unit associated with an EGM that interfaces with a SMIB in communication with the gaming establishment management system.

In certain embodiments, following any required authorizations from the gaming establishment management system to log the player into the gaming establishment management system, the system associates the player tracking account associated with the player mobile device application of the paired mobile device (or the physical instrument associated with the player tracking account) with the EGM and tracks activity associated with the player at the EGM. In certain embodiments, following any required authorizations from the gaming establishment management system to log the player into the gaming establishment management system, the system wirelessly communicates data associated with the player tracking account, such as the player tracking account number, to the SMIB (such that the SMIB proceeds as if a player with a physical player tracking card is at the EGM) and tracks activity associated with the player at the EGM. In these embodiments, the system logs the player into the EGM (including, but not limited to, a slot machine, a video poker machine, a video lottery terminal, a terminal associated with an electronic table game, a terminal associated with a live table game, a table game component associated with a gaming table, a video keno machine, a video bingo machine and/or a sports betting terminal (that offers sports betting opportunities and, in certain instances, wagering games)) and initiates a tracked session wherein zero, one or more activities or events occurring at the EGM will be recorded in association with the player's player tracking account. In certain embodiments, following a player successfully logging into an EGM using a player mobile device application of a mobile device, a display device of the EGM, a display device associated with the SMIB and/or the player mobile device application of the mobile device proceeds with displaying a confirmation message that the player is logged into the player loyalty account.

In various embodiments wherein the system enables a player to log into a gaming establishment management system using a mobile device executing a player mobile device application, after pairing the player mobile device with the EGM (and/or the SMIB), the player mobile device application communicates data associated with one or more requested actions to be performed to the EGM (and/or the SMIB). Such requested actions generally pertain to the above-described action associated with logging into a player account, an action associated with logging out of a player account, an action associated with an initiation of a transfer of funds from an external account, an action associated with an initiation of a transfer of funds between gaming establishment accounts, an action associated with an initiation of a transfer of monetary funds from a gaming establishment account associated with the player to the EGM, an action associated with an initiation of a transfer of non-monetary funds (i.e., non-cashable credits which may not be otherwise directly redeemable for cash) from a gaming establishment account associated with the player to the EGM, an action associated with a transfer of virtual ticket vouchers from the mobile device and/or a gaming establishment account associated with the player to the EGM, and/or an action associated with a transfer of promotional credits from a gaming establishment account associated with the player to the EGM. In certain embodiments, following a successful completion of the requested action and/or a denial to complete the requested action, a display device of the EGM, a display device associated with the SMIB and/or the player mobile device application of the mobile device proceeds with displaying one or more messages to the player regarding a status of the requested action.

In certain embodiments, the system utilizes one mobile device application to interact with the different components of the gaming establishment systems to undertake one or more actions, such as access a player account, and/or access funds maintained in one or more gaming establishment accounts. For example, utilizing the same player mobile device application, a mobile device interacts with both a cashless wagering system of a gaming establishment fund management system and an external account funding system in communication with the gaming establishment fund management system. In certain embodiments, the system utilizes multiple player mobile device applications to interact with the different components of the gaming establishment systems to undertake one or more actions, such as access a player account, and/or access funds maintained in one or more gaming establishment accounts. In certain embodiments, the player mobile device application is a location based digital wallet enabled application, such as a Passbook-enabled or Wallet-enabled application, which is accessible when the player enters a gaming establishment. In certain embodiments, the player mobile device application utilized is downloaded to the player mobile device from an application store. In certain embodiments, the player mobile device application utilized is downloaded to the mobile device from one or more websites affiliated with the gaming establishment (which are accessible directly by the player and/or by a link opened when the player scans a QR code associated with the EGM).

In addition to tracking one or more activities or events occurring at the EGM to be recorded in association with the player's player tracking account, the system determines if an intervention event has occurred in association with the EGM. In certain embodiments, an intervention event includes the EGM being in a state or condition that requires gaming establishment personnel to intervene. In one such embodiment, an intervention event includes a handpay lockup event wherein when an award amount associated with a game outcome obtained during a play of a game at the EGM, such as a jackpot award that exceeds the jurisdictional handpay limit, causes the EGM to lock up awaiting gaming establishment personnel intervention. In another such embodiment, an intervention event includes an error event, such as when a printer of the EGM is out of paper or a bill acceptor of the EGM is jammed, wherein gaming establishment personnel are required to service the EGM and cure the error. In certain embodiments, an intervention event includes the player requesting gaming establishment personnel to intervene. In one such embodiment, an intervention event includes a player disputing an outcome and/or award obtained during a play of a game at the EGM wherein the player has made one or more inputs, such as requesting service through a remote host controlled service window displayed by the EGM, to dispute an outcome and/or award. In another such embodiment, an intervention event includes a player pressing a service button, wherein, in certain instances, such an input operates to open/close a remote host controlled service window displayed by the EGM. In certain embodiments, an intervention event includes gaming establishment personnel making one or more inputs (at the EGM and/or remote from the EGM) to intervene. In one such embodiment, an intervention event includes an operator scheduled access of the EGM, such as to empty a cashbox of the EGM. It should be appreciated that any suitable event associated with the player at the EGM, independent of the player at the EGM, associated with an operator, independent of an operator, associated with a state of the EGM and/or independent of the state of the EGM may be employed as the intervention event of the present disclosure.

If the system determines that no intervention event has occurred in association with the EGM, the system continues to track activity associated with the player at the EGM. On the other hand, if the system determines that an intervention event has occurred in association with the EGM, the system enables an operator to use an operator mobile device application executed by a mobile device to log into the EGM (and/or a component associated with the EGM, such as the SMIB associated with the EGM). In these embodiments, the system enables the operator to use a second mobile device executing a second mobile device application associated with an operator identifier to log into the EGM (and/or a component associated with the EGM) to take any action associated with the intervention event that occurred. In these embodiment, the system enables such logging into the EGM using the second mobile device application of the second mobile device without using a physical instrument, such as a magnetic striped card, issued to the operator and without employing the first mobile device application of the first mobile device associated with the player account.

In certain embodiments, following the launching of an operator mobile device application and any requirement of the operator logging into the operator mobile device application, the operator mobile device application prompts the operator to cause the operator mobile device to engage the EGM (e.g., the operator taps the mobile device to a player tracking card reader or other designated location(s) of the EGM). After such engagement (or after the launching of the operator mobile device application if no operator mobile device engagement is required), the operator mobile device application attempts to pair with the EGM by communicating, via one or more wireless communication protocols, data associated with the operator, such as an operator identifier (e.g., a maintenance identifier) stored by the operator mobile device, to the EGM and/or a component of a gaming establishment management system located inside the EGM, such as the SMIB. In one such embodiment, the operator mobile device application communicates data to an antenna, such as a BLE antenna, which interfaces with the card reader of the player tracking unit associated with the EGM that interfaces with the SMIB in communication with the gaming establishment management system.

In certain embodiments, following the receipt of data associated with the operator identifier stored by the operator mobile device, such as following receipt of an operator's employee card number, the EGM (and/or the SMIB) attempts to validate the operator identifier provided by the operator mobile device. For example, following the receipt of an operator identifier from the operator mobile device, the EGM (and/or the SMIB) operates with a server of an operator management system to verify that the operator identifier associated with the operator mobile device is authentic.

If the EGM (and/or the SMIB) is unable to validate the operator identifier provided by the operator mobile device, the system prevents the operator from logging into the EGM (and/or any component associated with the EGM). For example, if the server of the operator management system notifies the EGM that the operator identifier is no longer valid because the gaming establishment personnel assigned that operator identifier is no longer employed by the gaming establishment, the EGM prevents such former gaming establishment personnel from logging into the EGM and accessing any controls of the EGM.

On the other hand, if the EGM (and/or the SMIB) validates the operator identifier provided by the operator mobile device, the system logs the operator into the EGM and enables the operator to take any action associated with the intervention event that occurred. For example, if the server of the operator management system notifies the EGM that the provided operator identifier is valid, the EGM (and/or the SMIB) enables various sets of information to be exchanged between the EGM (and/or the SMIB) and the operator mobile device application to facilitate the operator in addressing the intervention event that occurred.

In certain embodiments, as indicated above, prior to causing the operator mobile device executing the operator mobile device application to engage with the EGM (and/or the SMIB), the operator mobile device requires the operator to log into the operator mobile device application. In certain such embodiments wherein the operator mobile device is a shared device, the operator mobile device application supports multiple operators information wherein upon a particular operator logging into the operator mobile device, the operator mobile device application loads the information associated with that particular operator (such that, when in use, the operator mobile device application is aware of which operator is using the operator mobile device). In these embodiments, upon the operator logging into the operator mobile device application, the system enables the operator to configure the operator mobile device application with any personal data, such as employee ID number and name.

In certain embodiments, upon a determination that the provided operator identifier is valid, the system enables the operator to log into the EGM (and/or a component associated with the EGM, such as the SMIB) and obtain information associated with the EGM, such as a log of tracked events that occurred at the EGM. In certain embodiments, the system additionally or alternatively enables the operator to log into the EGM (and/or a component associated with the EGM, such as the SMIB) and obtain information associated with the player, such as a player account number associated with the player that logged into the EGM using the player mobile device application. In certain embodiments, the system additionally or alternatively enables the operator to log into the EGM (and/or a component associated with the EGM, such as the SMIB) and obtain information independent of the EGM and the player. In these embodiments, upon the operator using an operator mobile device application to log into the EGM (and/or the SMIB), the EGM (and/or the SMIB) alters how it operates to display certain information to the operator (and/or communicate certain information to the operator mobile device) not otherwise available to be displayed prior to the operator logging into the EGM (and/or the SMIB).

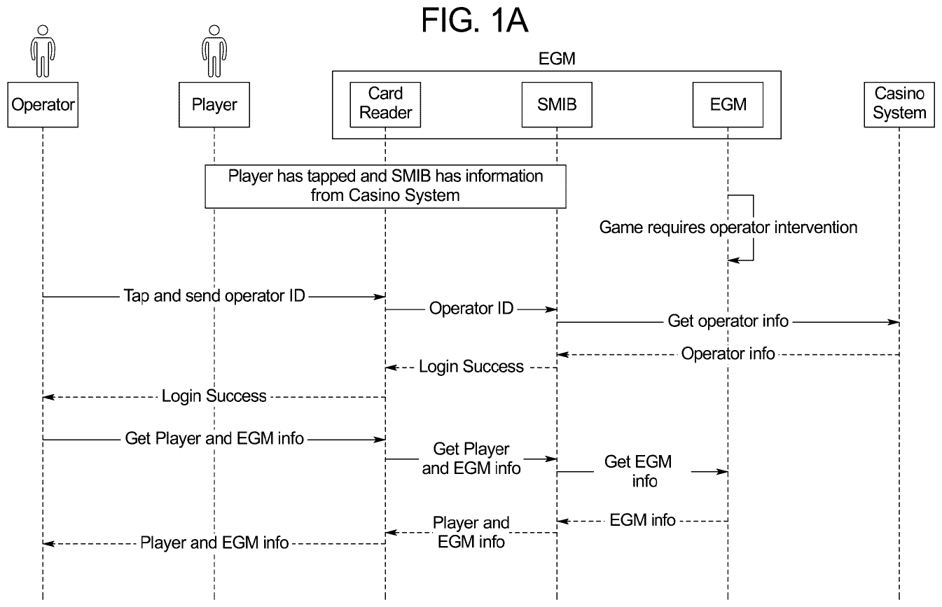

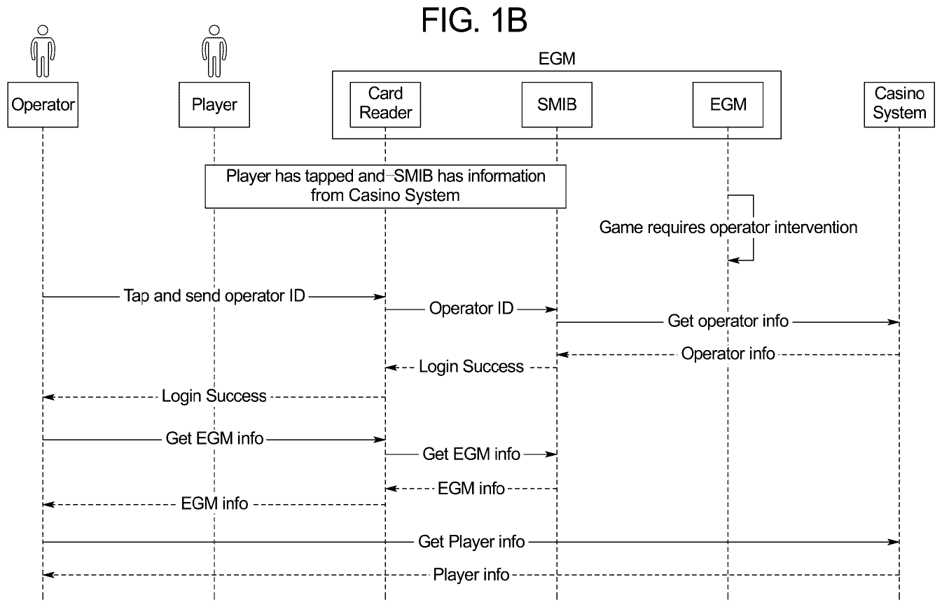

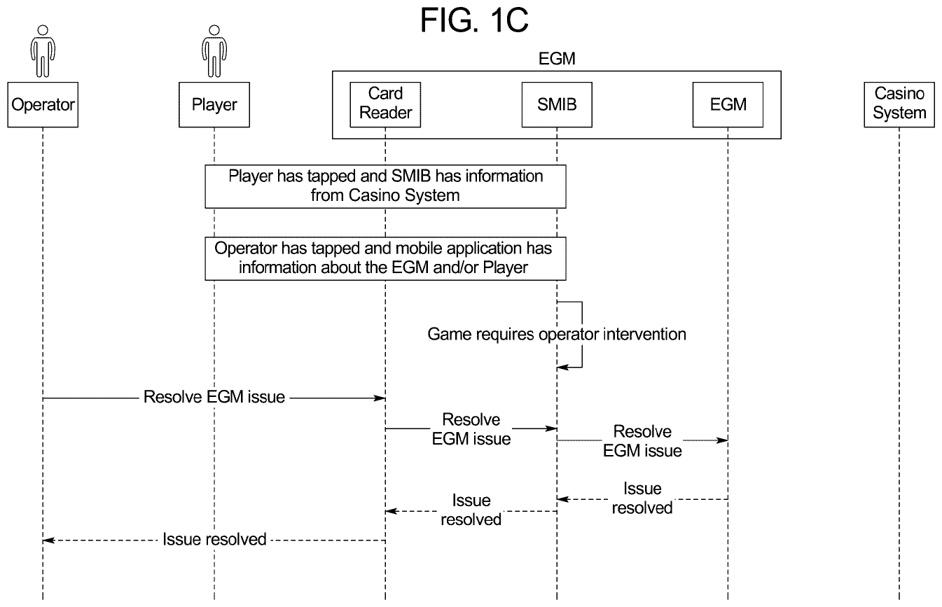

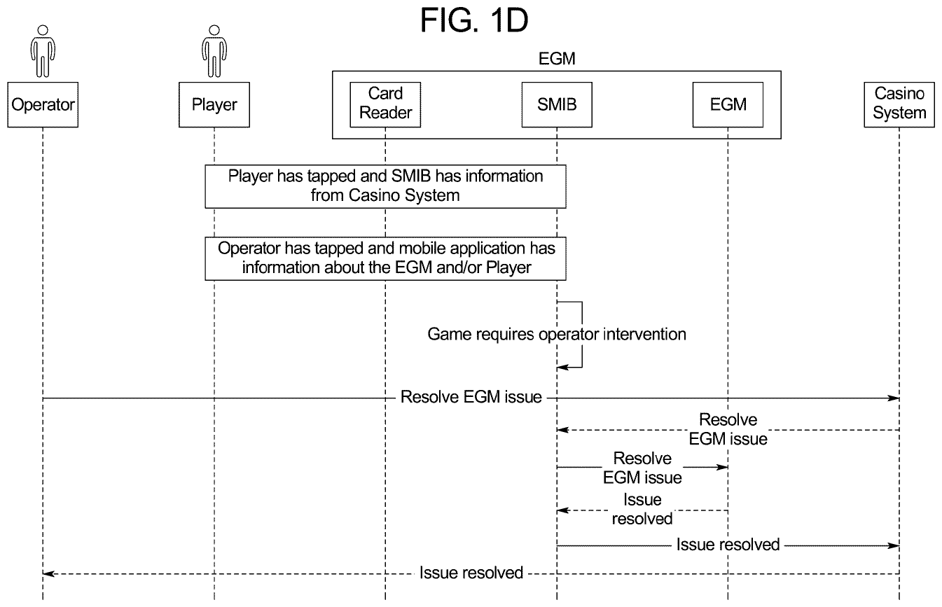

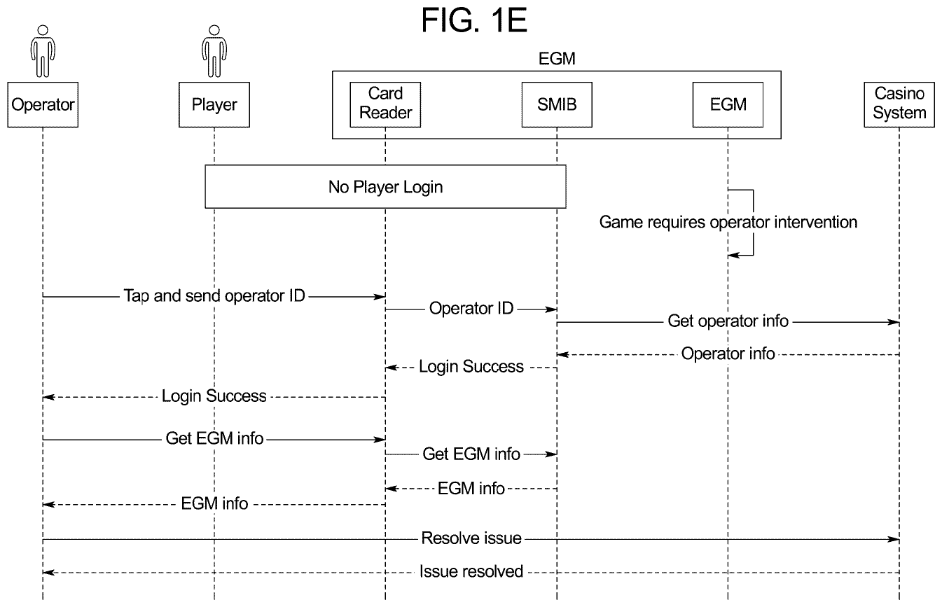

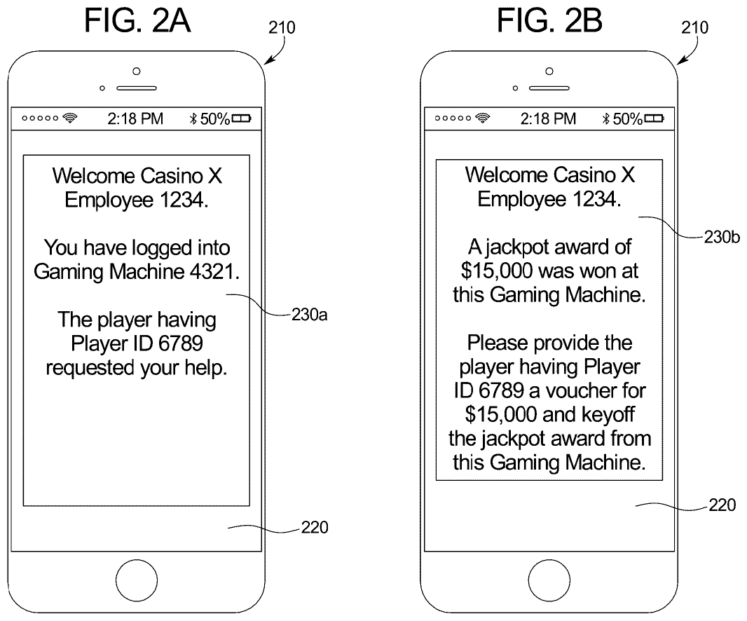

In certain embodiments, upon a determination that the provided operator identifier is valid, the EGM (and/or the SMIB) directly exchanges data with the operator mobile device executing the operator mobile device application to, in certain instances, facilitate the operator in addressing the intervention event that occurred. In one such embodiment, the data directly exchanged between the EGM (and/or the SMIB) and the operator mobile device application to facilitate the operator in addressing the intervention event that occurred includes player identification information, such as the player account number of the player whom logged in using the player mobile device application. In another such embodiment, the data directly exchanged between the EGM (and/or the SMIB) and the operator mobile device application to facilitate the operator in addressing the intervention event that occurred additionally or alternatively includes EGM information, such as historical activity associated with that EGM. In another such embodiment, the data directly exchanged between the EGM (and/or the SMIB) and the operator mobile device application to facilitate the operator in addressing the intervention event that occurred additionally or alternatively includes operator information, such as a log of any inputs made by a particular operator at that EGM. Accordingly, as seen in the example of FIG. 1A, a plurality of different components of the system of the present disclosure (i.e., an EGM, a card reader associated with the EGM, the SMIB associated with the EGM, the operator mobile device executing an operator mobile device application, and the casino system) interact with each other to potentially enable an operator to utilize the operator mobile device application to identify themselves to one or more components of the system and, following a verification from the casino system, such as a server of an operator management system, obtain information associated with the player whom logged in using the player mobile device application and/or obtain information associated with the EGM. For example, as seen in FIG. 2A, following an operator (e.g., Casino X employee having an operator identifier of 1234) successfully logging into an EGM (e.g., Gaming Machine 4321) using an operator mobile device 210 executing an operator mobile device application 220, the operator mobile device application interfaces with the EGM (and/or the SMIB) to obtain information associated with the player (e.g., the player having a Player ID of 6789 whom requested help at the EGM) and the EGM and the operator mobile device application proceeds with displaying such information to the operator 230a. It should be appreciated that in certain embodiments, such as the example embodiment illustrated in FIG. 1A, the system employs the same wireless communication channel used to log the operator into the EGM to communicate the various sets of information regarding the player and the EGM between the EGM (and/or the SMIB) and the operator mobile device application. For example, the operator mobile device application interacts with a Bluetooth™ enabled device or radio associated with the EGM (and/or the SMIB), such as a Bluetooth™ enabled card reader, to exchange both the operator identifier associated with the operator and information associated with the EGM that the operator has logged into.

In certain embodiments, upon a determination that the provided operator identifier is valid, the EGM (and/or the SMIB) as well as one or more components of a gaming establishment management system exchanges data with the operator mobile device executing the operator mobile device application to, in certain instances, facilitate the operator in addressing the intervention event that occurred. In one such embodiment, the data exchanged between the EGM (and/or the SMIB), one or more components of a gaming establishment system, such as a server of a gaming establishment patron management system, and the operator mobile device application to facilitate the operator in addressing the intervention event that occurred includes player identification information, such as the player account number of the player whom logged in using the player mobile device application. In one such embodiment, the data exchanged between the EGM (and/or the SMIB), one or more components of a gaming establishment system, such as a server of a gaming establishment patron management system, and the operator mobile device application to facilitate the operator in addressing the intervention event that occurred includes player tracking information, such as the player's name, playing tracking status or ranking, game play history, and/or wagering history. In another such embodiment, the data exchanged between the EGM (and/or the SMIB), one or more components of a gaming establishment system, such as a server of a gaming establishment EGM management system, and the operator mobile device application to facilitate the operator in addressing the intervention event that occurred additionally or alternatively includes EGM information, such historical activity associated with that EGM. In another such embodiment, the data exchanged between the EGM (and/or the SMIB), one or more components of a gaming establishment system, such as a server of an operator management system, and the operator mobile device application to facilitate the operator in addressing the intervention event that occurred additionally or alternatively includes operator information, such as a log of any inputs made by a particular operator at that EGM. Accordingly, as seen in the example of FIG. 1B, a plurality of different components of the system of the present disclosure (i.e., an EGM, a card reader associated with the EGM, the SMIB associated with the EGM, the operator mobile device executing an operator mobile device application, and the casino system) interact with each other to potentially enable an operator to utilize the operator mobile device application to identify themselves to one or more components of the system. In this example, following a verification from one component of the casino system, such as a server of an operator management system, of an identity of the operator, the operator mobile device application obtains from another component of the casino system, such as a server of a gaming establishment patron management system, information associated with the player whom logged in using the player mobile device application and/or obtains from the EGM (and/or the SMIB) information associated with the EGM. It should be appreciated that in certain embodiments, such as the example embodiment illustrated in FIG. 1B, the system employs the same wireless communication channel used to log the operator into the EGM to communicate certain sets of information, such as information regarding the EGM, between the EGM (and/or the SMIB) and the operator mobile device application. As further seen in this illustrated example, the system employs other communication channels to communicate certain other sets of information, such as information regarding the player, between the operator mobile device application and one or more components of the casino system. For example, the operator mobile device application interacts with a Bluetooth™ enabled device or radio associated with the EGM (and/or the SMIB), such as a Bluetooth™ enabled card reader, to exchange both the operator identifier associated with the operator and information associated with the EGM that the operator has logged into and the operator mobile device application additionally interacts with a component of a gaming establishment patron management system, such as a player tracking server, via another wireless communication protocol to exchange information regarding the player.

In certain embodiments, upon a determination that the provided operator identifier is valid, the system enables the operator to log into the EGM (and/or a component associated with the EGM, such as the SMIB) and intervene with the operation of the EGM. In these embodiments, in addition to or alternative from obtaining information regarding the player and/or the EGM, the system enables the operator to interface with the EGM (and/or the SMIB) to access one or more features or operations not otherwise available to the player. In certain embodiments, the system enables the operator to interface directly with the EGM (and/or the SMIB) by making one or more inputs utilizing an input device of the EGM (and/or an input device associated with the SMIB). In certain embodiments, the system additionally or alternatively enables the operator to interface with the EGM (and/or the SMIB) by making one or more inputs utilizing the operator mobile device application wherein data associated with such inputs is communicated to the EGM (and/or the SMIB) and/or another component of the system of the present disclosure. In certain of these embodiments, following an operator successfully logging into the EGM (and/or the SMIB), the EGM (and/or the SMIB) switches from a player mode of operation to an operator mode of operation wherein the operator may modify the EGM (and/or the SMIB) and wherein the actions undertaken by the operator are tracked by the EGM (and/or the SMIB).

In certain embodiments, upon logging into the EGM (and/or the SMIB), the operator undertakes one or more actions to resolve an issue with the EGM (and/or the SMIB) associated with the intervention event that occurred. That is, the operator interfaces with the one or more components of the system of the present disclosure to make zero, one or more inputs to perform zero, one or more actions in an attempt to address the circumstances that caused the intervention event to occur.

In certain embodiments, following the operator utilizing the operator mobile device application to log into the EGM (and/or the SMIB) and following the communication of data associated with the player and/or the EGM communicated to the operator mobile device application, the EGM (and/or the SMIB) directly exchanges data with the operator mobile device executing the operator mobile device application to resolve the issue associated with the intervention event that occurred. In these embodiments, to interface with the EGM (and/or the SMIB), the operator makes zero, one or more inputs via the operator mobile device executing the operator mobile device application (and/or via an input device of the EGM (and/or an input device associated with the SMIB) to resolve (or at least attempt to resolve) the issue associated with the intervention event that occurred. Accordingly, as seen in the example of FIG. 1C, a plurality of different components of the system of the present disclosure (i.e., an EGM, a card reader associated with the EGM, the SMIB associated with the EGM and the operator mobile device executing an operator mobile device application) interact with each other to enable an operator to utilize the operator mobile device application to resolve the issue, such as an EGM issue, that caused the intervention event to occur. It should be appreciated that as illustrated in FIG. 1C, in certain embodiments, the system employs the same wireless communication channel used to log the operator into the EGM to communicate data between the EGM (and/or the SMIB) and the operator mobile device application to resolve the issue that caused the intervention event to occur. For example, the operator mobile device application interacts with a Bluetooth™ enabled device or radio associated with the EGM (and/or the SMIB), such as a Bluetooth™ enabled card reader, to resolve one or more issues of the EGM that necessitated the operator's involvement.

In certain embodiments, following the operator utilizing the operator mobile device application to log into the EGM (and/or the SMIB) and following the communication of data associated with the player and/or the EGM communicated to the operator mobile device application, the EGM (and/or the SMIB) as well as one or more components of a gaming establishment system exchange data with the operator mobile device executing the operator mobile device application to resolve the issue associated with the intervention event that occurred. In these embodiments, to interface with the EGM (and/or the SMIB) and one or more components of the gaming establishment system, the operator makes zero, one or more inputs via the operator mobile device executing the operator mobile device application (and/or via an input device of the EGM (and/or an input device associated with the SMIB) to resolve (or at least attempt to resolve) the issue associated with the intervention event that occurred. Accordingly, as seen in the example of FIG. 1D, a plurality of different components of the system of the present disclosure (i.e., an EGM, a card reader associated with the EGM, the SMIB associated with the EGM, the operator mobile device executing an operator mobile device application and the casino system) interact with each other to enable an operator to utilize the operator mobile device application to resolve the issue, such as an EGM issue, that caused the intervention event to occur. In this example, following a verification from one component of the casino system, such as a server of an operator management system, of an identity of the operator and the retrieval of information regarding the EGM and/or the player, the operator mobile device application operates with another component of the casino system, such as a server of a gaming establishment EGM management system, to resolve (or attempt to resolve) one or more issues of the EGM that necessitated the operator's involvement. For example, as seen in FIG. 2B, following an operator successfully logging into an EGM using an operator mobile device 210 executing an operator mobile device application 220, the operator mobile device application interfaces with a server of a gaming establishment jackpot management system to obtain information associated with the EGM locking up in need of a handpay due to a jackpot award being won and the operator mobile device application proceeds with displaying instructions to the operator with how to keyoff such a jackpot award 230b. It should be appreciated that in certain embodiments, such as the example embodiment illustrated in FIG. 1D, the system employs the same wireless communication channel, such as a Bluetooth™ wireless communication protocol, used to log the operator into the EGM to communicate certain sets of information, such as information regarding the EGM and/or the player, between the EGM (and/or the SMIB) and the operator mobile device application. As further seen in this illustrated example, the system additionally employs other communication channels, such as a cellular (e.g., 3G, 4G, 5G, LTE) and/or Wi-Fi communication protocol, to communicate certain other sets of information, such as information associated with resolving the EGM issue, between the operator mobile device application and one or more components of the casino system.

In certain embodiments, an issue occurs in association with an EGM that causes an intervention event to occur while the player is playing anonymously at the EGM. In these embodiments, in resolving (or attempting to resolve) the issue, the system communicates information associated with the EGM and/or the anonymous player to the operator mobile device application wherein the operator employs the operator mobile device application to collect identifying information associated with the anonymous player (which may be required for taxation and/or reporting purposes). In certain such embodiments, following the operator utilizing the operator mobile device application to log into the EGM (and/or the SMIB) and following the communication of data associated with the EGM and/or data associated with the anonymous session active at the EGM being communicated to the operator mobile device application, the EGM (and/or the SMIB) and/or one or more components of a gaming establishment system exchange data with the operator mobile device executing the operator mobile device application to resolve the issue associated with the intervention event that occurred. In these embodiments, to interface with the EGM (and/or the SMIB) and/or one or more components of the gaming establishment system to resolve (or at least attempt to resolve) the issue associated with the intervention event that occurred as well as to manually input any collected information about the player, the operator makes zero, one or more inputs via the operator mobile device executing the operator mobile device application (and/or via an input device of the EGM (and/or an input device associated with the SMIB). Accordingly, as seen in the example of FIG. 1E, a plurality of different components of the system of the present disclosure (i.e., an EGM, a card reader associated with the EGM, the SMIB associated with the EGM, the operator mobile device executing an operator mobile device application and the casino system) interact with each other to enable an operator to utilize the operator mobile device application to log into the EGM, obtain information regarding the EGM, and resolve the issue, such as an EGM issue, that caused the intervention event to occur in association with the anonymous player. In this example, following a verification from one component of the casino system, such as a server of an operator management system, of an identity of the operator, following the communication of information regarding the EGM to the operator mobile device application and/or following the collection of player information from the anonymous player that the operator manually enters into the operator mobile device application, the operator mobile device application operates with another component of the casino system, such as a server of a gaming establishment EGM management system, to resolve (or attempt to resolve) one or more issues of the EGM that necessitated the operator's involvement.

In certain embodiments, different operators utilizing the operator mobile device application to interface with the EGM (and/or the SMIB) are associated with different permissions or levels of access. In these embodiments, the system determines the applicable permissions of the operator utilizing the operator mobile device application and configures the operator mobile device application (and/or the EGM or SMIB) to account for such permissions. That is, in association with the verification from a component of the casino system, such as a server of an operator management system, of an identity of the operator, the component communicates information to the operator mobile device application and/or the EGM (and/or the SMIB) regarding any permissions associated with the identified operator and/or any limitations placed on the identified operator. Following such information, the operator mobile device application and/or the EGM (and/or the SMIB) modify their operation to account for any permissions and/or limitations. In certain embodiments, the system determines zero, one or more permissions and/or limitations for each identified operator. In certain embodiments, the system additionally or alternatively determines zero, one or more permissions and/or limitations based on the role of the identified operator, wherein different operators having different roles are granted different permissions and/or limitations.

In one such example of how the system accounts for operator permissions, responsive to a handpay lockup event (i.e., an intervention event that occurs when an award amount associated with a game outcome obtained during a play of a game at the EGM, such as a jackpot award that exceeds the jurisdictional handpay limit, causes the EGM to lock up awaiting gaming establishment personnel intervention) and following an operator successfully logging into the EGM (and/or the SMIB) to pay the player and keyoff the amount of the award won from the credit meter balance of the EGM, the system tracks the actions of the operator and enforces zero, one or more permissions associated with the identified operator. In one such embodiment, the permission associated with the operator that the operator mobile device application (and/or EGM) enforces pertains to a limit on the amount of an award that an operator can process and pay the player. In another such embodiment, the permission associated with the operator that the operator mobile device application (and/or EGM) enforces pertains to a limit on a quantity of awards that an operator can process and pay players. In another such embodiment, the permission associated with the operator that the operator mobile device application (and/or EGM) enforces pertains to the type of keyoff operation, if any, the operator may engage in to resolve the handpay lockup event. For example, while an operator may or may not be required to turn a physical key of the EGM to “keyoff” a jackpot won that caused the handpay lockup event, since such physical keys may be lost over time and there is no way to associate a key with an operator security or permission level, depending on the permissions associated with an operator, the operator mobile device application includes a “keyoff” button that triggers the EGM (and/or the SMIB) and/or a component of the casino system to cause a “remote keyoff” of the jackpot won from the EGM. In this example, the system validates the permissions of the operator and utilizes the operator mobile device application and/or the EGM to limit or constrain what kind of jackpot “keyoff” operations the identified operator may perform, such as keying off to a credit meter of the EGM, keying off by providing an amount of cash to the player at the EGM, keying off to a gaming establishment account associated with the player, keying off to a voucher provided to the player (which is redeemable for cash) and/or performing a cancelled credit keyoff.

Accordingly, it should be appreciated that the system of the present disclosure enables a first user, such as a player, to use a first mobile device executing a first mobile device application, to interface with an EGM operating in a first mode of operation, such as a game play mode of operation. In these embodiments, responsive to a second user, such as an operator (e.g., a member of gaming establishment personnel) using a second mobile device executing a second mobile device application to interface with the EGM, the EGM switches to a second mode of operation, such as an operator mode of operation, wherein the operator may resolve any outstanding issues associated with the EGM and/or retrieve information regarding the first user and/or the EGM. As such, the system facilitates an EGM modifying how it operates (and specifically what information to display and what functions to enable) based on which of a plurality of different mobile devices executing which of a plurality of different mobile device applications is currently in wireless communication with the EGM. Such a configuration of multiple mobile devices that are each used to wirelessly exchange data with an EGM (and/or a component of a gaming establishment management system supported by the EGM, such as a SMIB, associated with the EGM) enables both players and operators to interface with the EGM without the need of any physical instruments inserted into a card reader of the EGM thus increasing mobility within a gaming establishment and saving users time in the event that such physical instruments are lost or damaged. Moreover, such as configuration of employing multiple mobile devices used to wirelessly exchange data with an EGM reduces the amount of physical contact that people have with the EGM which in turn reduces the role of the EGM as a vehicle to potentially transmit diseases between people thus fostering a safer environment.

In certain embodiments, as indicated above, prior to enabling a user, such as a player and/or an operator, to take any action related to the system, a pairing or linkage occurs between the mobile device and the gaming device, such as the EGM, wherein the pairing or linkage between the mobile device and the gaming device occurs via one or more applications being run or executed on the mobile device.

In certain embodiments, after a user, such as a player and/or an operator, has opened an application on a mobile device, logged into the application (if required) and selected an action to be performed, the system determines if the mobile device application (i.e., the player mobile device application if the user is a player or the operator mobile device application if the user is an operator) is associated with an active authorization token previously created by the system. In these embodiments, an authorization token is a time-based token which expires after a designated period of time and which is associated with an additional level of user authentication beyond a user's application username and application password.

If the system determines that the application is not associated with an active authorization token previously created by the system, the mobile device application prompts the user to provide identifying information, such as a personal identification number or biometric identifier. The mobile device application stores the provided identifying information as mobile device encrypted data. Following the user providing identifying information, the mobile device application prompts the user to cause the mobile device to engage the gaming device (e.g., the EGM), such as prompting the user to tap the mobile device to a designated portion of the EGM. It should be appreciated that any reference herein to a user tapping the mobile device to a designated portion of the gaming device may or may not include the user pressing a fingerprint scanner (if the mobile device is equipped with such a fingerprint scanner) while concurrently engaging the gaming device. In other embodiments, the mobile device application verifies the identifying information of the user by communicating with a verification/authentication server over one or more wireless communication protocols, such as WiFi protocol, a cellular communication protocol, to obtain the active authorization token. In certain embodiments, following the user causing the mobile device to engage the gaming device (e.g., the user taps the mobile device to a player tracking card reader or other designated location(s) of an EGM), the mobile device application communicates, via a wireless communication protocol, the provided identifying information and the requested action to be performed to the gaming device. For example, upon the user tapping the mobile device to a player tracking card reader or other designated location(s) of the EGM (or otherwise moving the mobile device to within a designated distance of the player tracking card reader or other designated locations(s) of the EGM), the mobile device application sends the identifying information and the requested action to a component of a gaming establishment management system located inside the EGM, such as the SMIB. Following the communication of the identifying information and the requested action to the gaming device, the system determines if the identifying information is valid. If the system determines that the identifying information is invalid, the system communicates an invalid identifying information response to the mobile device. For example, an identifying information status message is communicated to the mobile device which reports whether the identifying information is valid or invalid. The mobile device application then displays one or more messages regarding the invalid identifying information and prompts the user to provide identifying information, such as a personal identification number or biometric identifier. In certain such embodiments, if the mobile device receives a communication that the identifying information is invalid (or alternatively in association with the initial creation of a token) and if the mobile device includes a fingerprint scanner, the mobile device application prompts the user to press the fingerprint scanner while engaging the gaming device, such as tapping the mobile device to a designated portion of an EGM. If the system determines that the identifying information is valid, the system creates an authorization token. The system associates the authorization token with a timestamp of when the authorization token will expire. In certain embodiments, the authorization token expires after a designated period of time as an additional level of security. Following the creation of an authorization token, the system communicates the created authorization token to the mobile device, such as via one or more messages including the created authorization token, for storage by the mobile device application and proceeds with executing one or more of the requested actions and communicating a requested action response to the mobile device.

On the other hand, if the system determines that the mobile device application is associated with a previously created and stored authentication token, the mobile device application prompts the user to cause the mobile device to engage the gaming device, such as prompting the user to tap the mobile device to a designated portion of the EGM. Following the user causing the mobile device to engage the gaming device (e.g., the user taps the mobile device to a player tracking card reader or other designated location(s) of the EGM), the mobile device application communicates, via a wireless communication protocol, the previously stored authorization token and the requested action to be performed to the gaming device. Following the communication of the stored authorization token and the requested action to the gaming device, the system determines if the communicated authorization token is still valid. For example, a system component configured to operate with a player tracking system determines whether the authorization token is valid (i.e., active and non-expired). If the system determines that the communication authorization token is invalid, the system communicates an invalid authorization token response to the mobile device. The mobile device application then displays one or more messages regarding the invalid authorization token and prompts the user to provide identifying information, such as a personal identification number or biometric identifier, to obtain another authentication token. On the other hand, if the system determines that the stored authorization token is valid, the system proceeds with executing the requested action.

In certain embodiments, the system enables a user to interact with the gaming device via the mobile device, without having to continually reengage the gaming device with the mobile device for each requested action. In these embodiments, after initially establishing a secure connection with the gaming device, subsequent interactions between the mobile device application and the gaming device occur without any subsequent physical interaction between the mobile device and the gaming device. That is, to avoid having the user retrieve the mobile device and repeat the physical operation of engaging the gaming device with the mobile device, certain embodiments enable the user to execute one or more functions without repeating the above-described physical operation of engaging the gaming device with the mobile device. In certain such embodiments, the mobile device application utilizes one or more display devices of the gaming device to display to the user information and/or user selectable prompts which are otherwise displayable via the display device of the mobile device.

In certain other embodiments, for each interaction or requested action between the gaming device and the mobile device, the system requires the user to reengage the gaming device with the mobile device to reestablish or confirm the pairing between the gaming device and the mobile device. In certain other embodiments, for each interaction between the gaming device and the mobile device that occur a designated amount of time after the last engagement of the gaming device with the mobile device, the system requires the user to reengage the gaming device with the mobile device to reestablish or confirm the pairing between the gaming device and the mobile device.

It should be appreciated that any functionality or process of the present disclosure may be implemented via one or more servers, one or more EGMs, one or more components of an EGM, one or more gaming establishment components (such as a component of a gaming establishment management system (e.g., a player tracking unit) supported by or otherwise located inside the EGM), or a mobile device application. For example, while certain data or information of the present disclosure is explained as being communicated from an EGM, a component associated with an EGM, or a gaming establishment component (such as a component of a gaming establishment management system (e.g., a player tracking unit) supported by or otherwise located inside the EGM) to a mobile device via one or more wireless communication protocols, such data or information may additionally or alternatively be communicated from one or more servers to a mobile device via one or more wireless communication protocols. Accordingly: (i) while certain functions, features or processes are described herein as being performed by an EGM or a component associated with an EGM, such functions, features or processes may alternatively be performed by one or more servers, or one or more mobile device applications, or one or more gaming establishment components (such as a component of a gaming establishment management system (e.g., a player tracking unit) supported by or otherwise located inside the EGM), (ii) while certain functions, features or processes are described herein as being performed by one or more mobile device applications, such functions, features or processes may alternatively be performed by one or more servers, one or more EGMs, one or more components of an EGM, or one or more gaming establishment components (such as a component of a gaming establishment management system (e.g., a player tracking unit) supported by or otherwise located inside the EGM), (iii) while certain functions, features or processes are described herein as being performed by one or more servers, such functions, features or processes may alternatively be performed by one or more EGMs, one or more components of an EGM, one or more mobile device applications, or one or more gaming establishment components (such as a component of a gaming establishment management system (e.g., a player tracking unit) supported by or otherwise located inside the EGM), and (iv) while certain functions, features or processes are described herein as being performed by one or more gaming establishment components (such as a component of a gaming establishment management system (e.g., a player tracking unit) supported by or otherwise located inside the EGM), such functions, features or processes may alternatively be performed by one or more EGMs, one or more components of an EGM, one or more mobile device applications, or one or more servers.

It should be appreciated that while described in relation to a player and operator logging into an EGM using respective mobile device applications, the above-described embodiments of the present disclosure may be implemented in accordance with or in conjunction with one or more of a variety of different types of gaming systems. The present disclosure thus contemplates a variety of different gaming systems each having one or more of a plurality of different features, attributes, or characteristics. In such embodiments, the gaming system includes: (a) one or more electronic gaming machines in combination with one or more servers; (b) a single electronic gaming machine; (c) a plurality of electronic gaming machines in combination with one another; (d) a single server; and/or (e) a plurality of servers in combination with one another.

In various embodiments, the gaming system includes an EGM in combination with a server. In such embodiments, the EGM is configured to communicate with the server through a data network or remote communication link. In certain such embodiments, the EGM is configured to communicate with another EGM through the same data network or remote communication link or through a different data network or remote communication link. For example, the gaming system includes a plurality of EGMs that are each configured to communicate with a server through a data network.

In certain embodiments in which the gaming system includes an EGM in combination with a server, the server is any suitable computing device (such as a server) that includes at least one processor and at least one memory device or data storage device. As further described herein, the EGM includes at least one EGM processor configured to transmit and receive data or signals representing events, messages, commands, or any other suitable information between the EGM and the server. The at least one processor of that EGM is configured to execute the events, messages, or commands represented by such data or signals in conjunction with the operation of the EGM. Moreover, the at least one processor of the server is configured to transmit and receive data or signals representing events, messages, commands, or any other suitable information between the server and the EGM. The at least one processor of the server is configured to execute the events, messages, or commands represented by such data or signals in conjunction with the operation of the server. One, more than one, or each of the functions of the server may be performed by the at least one processor of the EGM. Further, one, more than one, or each of the functions of the at least one processor of the EGM may be performed by the at least one processor of the server.

In certain such embodiments, computerized instructions for controlling any games (such as any primary or base games and/or any secondary or bonus games) displayed by the EGM are executed by the server. In such “thin client” embodiments, the server remotely controls any games (or other suitable interfaces) displayed by the EGM, and the EGM is utilized to display such games (or suitable interfaces) and to receive one or more inputs or commands. In other such embodiments, computerized instructions for controlling any games displayed by the EGM are communicated from the server to the EGM and are stored in at least one memory device of the EGM. In such “thick client” embodiments, the at least one processor of the EGM executes the computerized instructions to control any games (or other suitable interfaces) displayed by the EGM.

In various embodiments in which the gaming system includes a plurality of EGMs, one or more of the EGMs are thin client EGMs and one or more of the EGMs are thick client EGMs. In other embodiments in which the gaming system includes one or more EGMs, certain functions of one or more of the EGMs are implemented in a thin client environment, and certain other functions of one or more of the EGMs are implemented in a thick client environment. In one such embodiment in which the gaming system includes an EGM and a server, computerized instructions for controlling any primary or base games displayed by the EGM are communicated from the server to the EGM in a thick client configuration, and computerized instructions for controlling any secondary or bonus games or other functions displayed by the EGM are executed by the server in a thin client configuration.

In certain embodiments in which the gaming system includes: (a) an EGM configured to communicate with a server through a data network; and/or (b) a plurality of EGMs configured to communicate with one another through a data network, the data network is a local area network (LAN) in which the EGMs are located substantially proximate to one another and/or the server. In one example, the EGMs and the server are located in a gaming establishment or a portion of a gaming establishment.

In other embodiments in which the gaming system includes: (a) an EGM configured to communicate with a server through a data network; and/or (b) a plurality of EGMs configured to communicate with one another through a data network, the data network is a wide area network (WAN) in which one or more of the EGMs are not necessarily located substantially proximate to another one of the EGMs and/or the server. For example, one or more of the EGMs are located: (a) in an area of a gaming establishment different from an area of the gaming establishment in which the server is located; or (b) in a gaming establishment different from the gaming establishment in which the server is located. In another example, the server is not located within a gaming establishment in which the EGMs are located. In certain embodiments in which the data network is a WAN, the gaming system includes a server and an EGM each located in a different gaming establishment in a same geographic area, such as a same city or a same state. Gaming systems in which the data network is a WAN are substantially identical to gaming systems in which the data network is a LAN, though the quantity of EGMs in such gaming systems may vary relative to one another.

In further embodiments in which the gaming system includes: (a) an EGM configured to communicate with a server through a data network; and/or (b) a plurality of EGMs configured to communicate with one another through a data network, the data network is an internet (such as the Internet) or an intranet. In certain such embodiments, an Internet browser of the EGM is usable to access an Internet game page from any location where an Internet connection is available. In one such embodiment, after the EGM accesses the Internet game page, the server identifies a player before enabling that player to place any wagers on any plays of any wagering games. In one example, the server identifies the player by requiring a player account of the player to be logged into via an input of a unique username and password combination assigned to the player. The server may, however, identify the player in any other suitable manner, such as by validating a player tracking identification number associated with the player; by reading a player tracking card or other smart card inserted into a card reader (as described below); by validating a unique player identification number associated with the player by the server; or by identifying the EGM, such as by identifying the MAC address or the IP address of the Internet facilitator. In various embodiments, once the server identifies the player, the server enables placement of one or more wagers on one or more plays of one or more primary or base games and/or one or more secondary or bonus games, and displays those plays via the Internet browser of the EGM.

The server and the EGM are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

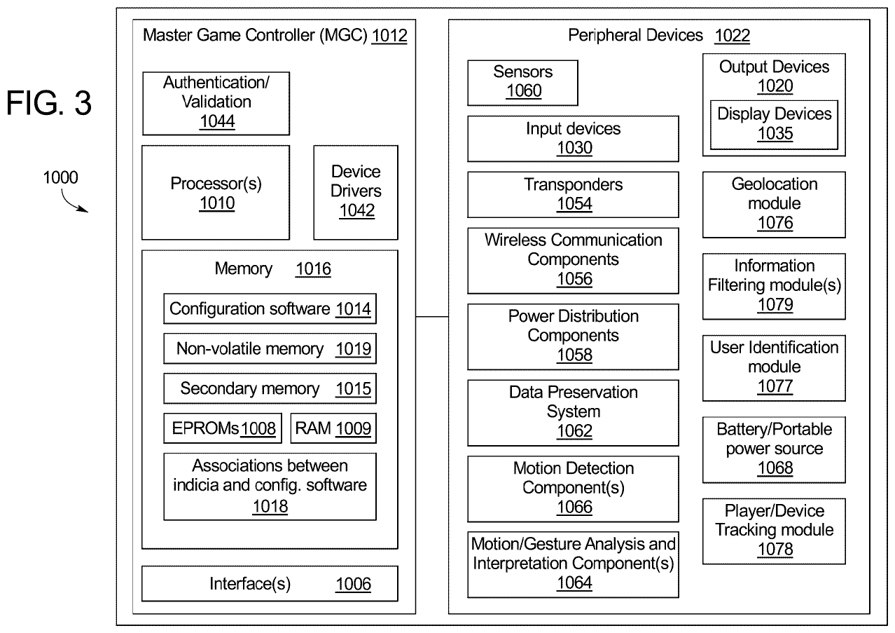

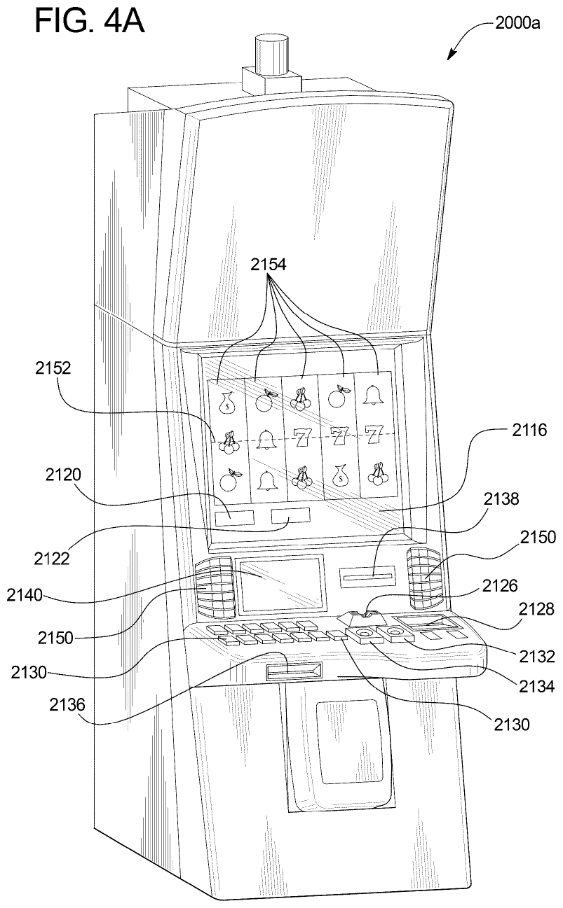

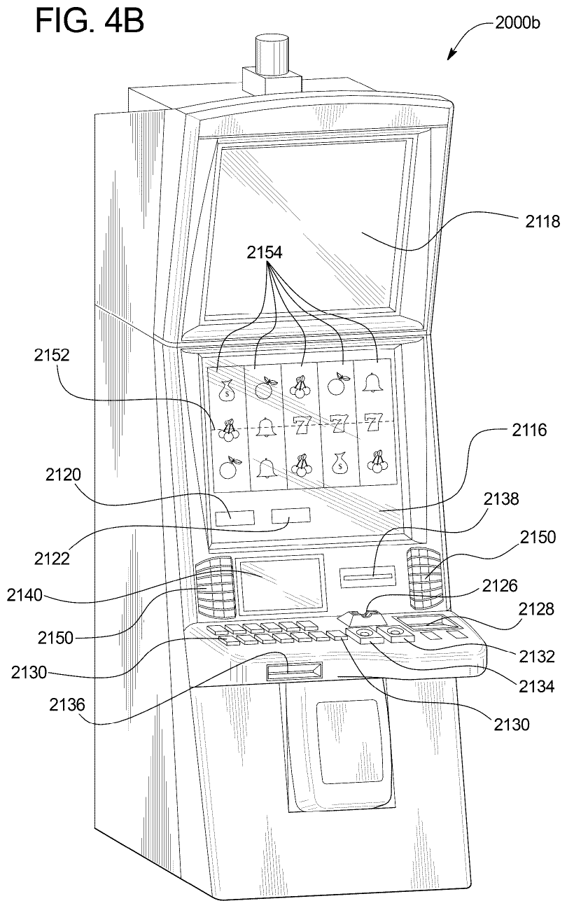

FIG. 3 is a block diagram of an example EGM 1000 and FIGS. 4A and 4B include two different example EGMs 2000a and 2000b. The EGMs 1000, 2000a, and 2000b are merely example EGMs, and different EGMs may be implemented using different combinations of the components shown in the EGMs 1000, 2000a, and 2000b.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game parameters in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM of the present disclosure. In certain embodiments, the at least one memory device 1016 resides within the housing of the EGM (described below), while in other embodiments at least one component of the at least one memory device 1016 resides outside of the housing of the EGM. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device 1016 is configured to store, for example: (1) configuration software 1014, such as all the parameters and settings for a game playable on the EGM; (2) associations 1018 between configuration indicia read from an EGM with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, user input device components, information received from one or more user input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 4A includes a central display device 2116, a player tracking display 2140, a credit display 2120, and a bet display 2122. The example EGM 2000b illustrated in FIG. 4B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 4A and 4B each include a ticket printer and dispenser 2136.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 4A and 4B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 4A and 4B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 4A and 4B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance. The example EGMs 2000a and 2000b illustrated in FIGS. 4A and 4B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons icon displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 4A and 4B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 4A and 4B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the EGM. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., user input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 300 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one user identification module 1077 is configured to determine the identity of the current user or current owner of the EGM. For example, in one embodiment, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example EGMs 2000a and 2000b illustrated in FIGS. 4A and 4B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 4A and 4B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all gaming systems, and these example EGMs may not include one or more elements that are included in other gaming systems. For example, certain EGMs include a coin acceptor while others do not.

In various embodiments, an EGM may be implemented in one of a variety of different configurations. In various embodiments, the EGM may be implemented as one of: (a) a dedicated EGM in which computerized game programs executable by the EGM for controlling any primary or base games (referred to herein as “primary games”) and/or any secondary or bonus games or other functions (referred to herein as “secondary games”) displayed by the EGM are provided with the EGM before delivery to a gaming establishment or before being provided to a player; and (b) a changeable EGM in which computerized game programs executable by the EGM for controlling any primary games and/or secondary games displayed by the EGM are downloadable or otherwise transferred to the EGM through a data network or remote communication link; from a USB drive, flash memory card, or other suitable memory device; or in any other suitable manner after the EGM is physically located in a gaming establishment or after the EGM is provided to a player.

As generally explained above, in various embodiments in which the gaming system includes a server and a changeable EGM, the at least one memory device of the server stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the server is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the server to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the gaming system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the gaming system generates the game outcome(s) and/or the award(s) to be provided based on the associated probabilities. In these embodiments, since the gaming system generates game outcomes and/or awards randomly or based on one or more probability calculations, there is no certainty that the gaming system will ever provide any specific game outcome and/or award.

In certain embodiments, the gaming system maintains one or more predetermined pools or sets of predetermined game outcomes and/or awards. In certain such embodiments, upon generation or receipt of a game outcome and/or award request, the gaming system independently selects one of the predetermined game outcomes and/or awards from the one or more pools or sets. The gaming system flags or marks the selected game outcome and/or award as used. Once a game outcome or an award is flagged as used, it is prevented from further selection from its respective pool or set; that is, the gaming system does not select that game outcome or award upon another game outcome and/or award request. The gaming system provides the selected game outcome and/or award.

In certain embodiments, the gaming system determines a predetermined game outcome and/or award based on the results of a bingo, keno, or lottery game. In certain such embodiments, the gaming system utilizes one or more bingo, keno, or lottery games to determine the predetermined game outcome and/or award provided for a primary game and/or a secondary game. The gaming system is provided or associated with a bingo card. Each bingo card consists of a matrix or array of elements, wherein each element is designated with separate indicia. After a bingo card is provided, the gaming system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards.

In certain embodiments in which the gaming system includes a server and an EGM, the EGM is configured to communicate with the server for monitoring purposes only. In such embodiments, the EGM determines the game outcome(s) and/or award(s) to be provided in any of the manners described above, and the server monitors the activities and events occurring on the EGM. In one such embodiment, the gaming system includes a real-time or online accounting and gaming information system configured to communicate with the server. In this embodiment, the accounting and gaming information system includes: (a) a player database configured to store player profiles, (b) a player tracking module configured to track players (as described below), and (c) a credit system configured to provide automated transactions.

As noted above, in various embodiments, the gaming system includes one or more executable game programs executable by at least one processor of the gaming system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the gaming system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the gaming system. In certain such embodiments, the gaming system includes one or more paylines associated with the reels. The example EGM 2000b shown in FIG. 4B includes a payline 1152 and a plurality of reels 1154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The gaming system enables a wager to be placed on one or more of such paylines to activate such paylines. In other embodiments in which one or more paylines are formed between at least two adjacent symbol display areas, the gaming system enables a wager to be placed on a plurality of symbol display areas, which activates those symbol display areas.

In various embodiments, the gaming system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the gaming system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided.

In various embodiments, the gaming system includes a progressive award. Typically, a progressive award includes an initial amount and an additional amount funded through a portion of each wager placed to initiate a play of a primary game. When one or more triggering events occurs, the gaming system provides at least a portion of the progressive award. After the gaming system provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the gaming system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game.

In various embodiments, the gaming system automatically provides or initiates the secondary game upon the occurrence of a triggering event or the satisfaction of a qualifying condition. In other embodiments, the gaming system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the gaming system randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the gaming system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the gaming system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards.

In various embodiments, the gaming system includes one or more player tracking systems. Such player tracking systems enable operators of the gaming system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the gaming system to begin a gaming session, the card reader reads the player identification number off the player tracking card to identify the player. The gaming system timely tracks any suitable information or data relating to the identified player's gaming session. The gaming system also timely tracks when the player tracking card is removed to conclude play for that gaming session. In another embodiment, rather than requiring insertion of a player tracking card into the card reader, the gaming system utilizes one or more portable devices, such as a mobile phone, a radio frequency identification tag, or any other suitable wireless device, to track when a gaming session begins and ends. In another embodiment, the gaming system utilizes any suitable biometric technology or ticket technology to track when a gaming session begins and ends.

In such embodiments, during one or more gaming sessions, the gaming system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

In certain embodiments, the gaming system is configured to communicate with a social network server that hosts or partially hosts a social networking website via a data network (such as the Internet) to integrate a player's gaming experience with the player's social networking account. This enables the gaming system to send certain information to the social network server that the social network server can use to create content (such as text, an image, and/or a video) and post it to the player's wall, newsfeed, or similar area of the social networking website accessible by the player's connections (and in certain cases the public) such that the player's connections can view that information. This also enables the gaming system to receive certain information from the social network server, such as the player's likes or dislikes or the player's list of connections. In certain embodiments, the gaming system enables the player to link the player's player account to the player's social networking account(s). This enables the gaming system to, once it identifies the player and initiates a gaming session (such as via the player logging into an EGM), link that gaming session to the player's social networking account(s). In other embodiments, the gaming system enables the player to link the player's social networking account(s) to individual gaming sessions when desired by providing the required login information.

For instance, in one embodiment, if a player wins a particular award (e.g., a progressive award or a jackpot award) or an award that exceeds a certain threshold (e.g., an award exceeding $1,000), the gaming system sends information about the award to the social network server to enable the server to create associated content (such as a screenshot of the outcome and associated award) and to post that content to the player's wall (or other suitable area) of the social networking website for the player's connections to see (and to entice them to play). In another embodiment, if a player joins a multiplayer game and there is another seat available, the gaming system sends that information to the social network sever to enable the server to create associated content (such as text indicating a vacancy for that particular game) and to post that content to the player's wall (or other suitable area) of the social networking website for the player's connections to see (and to entice them to fill the vacancy). In another embodiment, if the player consents, the gaming system sends advertisement information or offer information to the social network server to enable the social network server to create associated content (such as text or an image reflecting an advertisement and/or an offer) and to post that content to the player's wall (or other suitable area) of the social networking website for the player's connections to see. In another embodiment, the gaming system enables the player to recommend a game to the player's connections by posting a recommendation to the player's wall (or other suitable area) of the social networking website.

Certain of the gaming systems described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general purpose computing device.

A second difference between EGMs and general purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general purpose computing devices is that EGMs have unique peripheral device requirements that differ from those of a general purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A slot machine interface board comprising:
a first wired communication interface supported by a housing of an electronic gaming machine and operable to serially communicate, in accordance with a slot accounting system protocol, with a master gaming controller of the electronic gaming machine;
a second communication interface supported by the housing of the electronic gaming machine, the second communication interface being different from the first wired communication interface and operable to communicate with a server of a gaming establishment patron management system;
a third communication interface supported by the housing of the electronic gaming machine, the third communication interface being different from the first wired communication interface, different from the second communication interface and operable to communicate with a server of a gaming establishment electronic gaming machine management system;
a processor supported by the housing of the electronic gaming machine; and
a memory device that stores a plurality of instructions that, when executed by the processor, cause the processor to:
responsive to a receipt of first data associated with a player account wirelessly communicated from a first mobile device executing a first mobile device application when the electronic gaming machine is operating in a player configuration state, operate with the server of the gaming establishment patron management system to establish, based on data communicated via the second communication interface, a player session associated with the player account, and
before a termination event occurs in association with the player session, after an occurrence of an event associated with a required operator intervention, and responsive to a receipt of second data associated with an operator identifier wirelessly communicated from a second mobile device executing a second mobile device application:
cause a communication, via the first wired communication interface, of data that results in a modification of the electronic gaming machine to operating in an operator configuration state, and
operate with the server of the gaming establishment electronic gaming machine management system to establish, in association with the electronic gaming machine operating in the operator configuration state and based on data communicated via the third communication interface, an operator session associated with an operator.

2. The slot machine interface board of claim 1, wherein the memory device stores a plurality of further instructions that, when executed by the processor responsive to the establishment of the operator session, cause the processor to cause a communication of third data associated with the electronic gaming machine to the second mobile device executing the second mobile device application.

3. The slot machine interface board of claim 2, wherein the third data comprises data associated with an enablement of a function of the electronic gaming machine disabled prior to the establishment of the operator session.

4. The slot machine interface board of claim 1, wherein the memory device stores a plurality of further instructions that, when executed by the processor responsive to the establishment of the operator session, cause the processor to cause a communication of third data associated with the player account to the second mobile device executing the second mobile device application.

5. The slot machine interface board of claim 1, wherein responsive to the establishment of the operator session, the second mobile device executing the second mobile device application wirelessly receives third data associated with the player account from the server of the gaming establishment patron management system.

6. The slot machine interface board of claim 1, wherein the memory device stores a plurality of further instructions that, when executed by the processor, cause the processor to operate with the server of the gaming establishment electronic gaming machine management system to establish the operator session responsive to a validation of the operator identifier from the server of the gaming establishment electronic gaming machine management system.

7. The slot machine interface board of claim 1, wherein the memory device stores a plurality of further instructions that, when executed by the processor, cause the processor to operate with the second mobile device application to cause the modification of the electronic gaming machine to being in the operator configuration state.

8. The slot machine interface board of claim 1, wherein the memory device stores a plurality of further instructions that, when executed by the processor, cause the processor to operate with the server of the gaming establishment electronic gaming machine management system to cause the modification of the electronic gaming machine to being in the operator configuration state.

9. The slot machine interface board of claim 1, wherein the memory device stores a plurality of further instructions that, when executed by the processor responsive to a receipt, when the electronic gaming machine is operating in the player configuration state, of the data associated with the player account from a card reader supported by the housing of the electronic gaming machine, cause the processor to operate with the server of the gaming establishment patron management system to establish, based on data communicated from the card reader, the player session associated with the player account.

10. A slot machine interface board comprising:
a processor; and
a memory device that stores a plurality of instructions that, when executed by the processor following an establishment of a player session that occurs independent of a card reader associated with an electronic gaming machine receiving any physical identifier encoded with player account data and based on receiving, via a wireless communication channel, the player account data, cause the processor to:
responsive to a receipt, via the wireless communication channel, of data from a mobile device executing a mobile device application associated with an operator identifier and prior to a termination of the player session:
operate with a server of a gaming establishment electronic gaming machine management system to establish, at the electronic gaming machine, an operator session associated with the operator identifier, and
cause a communication of data associated with the electronic gaming machine to the mobile device, wherein player account data associated with a player is communicated to the mobile device via the same wireless communication channel.

11. The slot machine interface board of claim 10, wherein the player session is associated with the electronic gaming machine operating in a player configuration state associated with a disablement of a function of the electronic gaming machine and the operator session is associated with the electronic gaming machine operating in an operator configuration state associated with an enablement of the function of the electronic gaming machine.

12. A method of operating a slot machine interface board, the method comprising:
responsive to a receipt of first data associated with a player account wirelessly communicated from a first mobile device executing a first mobile device application when an electronic gaming machine is operating in a player configuration state, operating, by a processor of the slot machine interface board, with a server of a gaming establishment patron management system to establish, based on data communicated via a communication interface, a player session associated with the player account, and
before a termination event occurs in association with the player session, after an occurrence of an event associated with a required operator intervention, and responsive to a receipt of second data associated with an operator identifier wirelessly communicated from a second mobile device executing a second mobile device application:
causing a communication, via a wired communication interface, of data that results in a modification of the electronic gaming machine to operating in an operator configuration state, and
operating, by the processor of the slot machine interface board, with a server of a gaming establishment electronic gaming machine management system to establish, in association with the electronic gaming machine operating in the operator configuration state and based on data communicated via another communication interface, an operator session associated with an operator.

13. The method of claim 12, further comprising, responsive to the establishment of the operator session, causing a communication of third data associated with the electronic gaming machine to the second mobile device executing the second mobile device application.

14. The method of claim 13, wherein the third data comprises data associated with an enablement of a function of the electronic gaming machine disabled prior to the establishment of the operator session.

15. The method of claim 12, further comprising, responsive to the establishment of the operator session, causing a communication of third data associated with the player account to the second mobile device executing the second mobile device application.

16. The method of claim 12, wherein responsive to the establishment of the operator session, the second mobile device executing the second mobile device application wirelessly receives third data associated with the player account from the server of the gaming establishment patron management system.

17. The method of claim 12, further comprising operating, by the processor of the slot machine interface board, with the server of the gaming establishment electronic gaming machine management system to establish the operator session responsive to a validation of the operator identifier from the server of the gaming establishment electronic gaming machine management system.

18. The method of claim 12, further comprising operating, by the processor of the slot machine interface board, with the second mobile device application to cause the modification of the electronic gaming machine to being in the operator configuration state.

19. The method of claim 12, further comprising operating, by the processor of the slot machine interface board, with the server of the gaming establishment electronic gaming machine management system to cause the modification of the electronic gaming machine to being in the operator configuration state.

20. The method of claim 12, further comprising, responsive to a receipt, when the electronic gaming machine is operating in the player configuration state, of the data associated with the player account from a card reader supported by the housing of the electronic gaming machine, operating, by the processor of the slot machine interface board, with the server of the gaming establishment patron management system to establish, based on data communicated from the card reader, the player session associated with the player account.
